(19) United States
(12) Patent Application Publication
(10) Pub. No.: US 2009/0271443 A1
(43) Pub. Date: Oct. 29, 2009

(54) METHOD FOR DETECTING DATA ATTRIBUTE DEPENDENCIES

(75) Inventors: Peter J. Haas, San Jose, CA (US); Fabian Hueske, Soest (DE); Volker G. Markl, San Jose, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/111,645

(22) Filed: Apr. 29, 2008

(51) Int. Cl. G06F 17/30

(52) U.S. Cl. 707/200; 707/E17.007

(57) ABSTRACT

A method for detecting data attribute dependencies including obtaining at least one data attribute pair of a dataset to analyze for dependency, obtaining at least one query feedback record related to the data attribute pair, obtaining at least one observation of the data attribute pair from the query feedback record that includes a selectivity and at least one of a first marginal selectivity or a second marginal selectivity, completing the observation, if it does not include the first marginal selectivity and the second marginal selectivity, by estimating the missing marginal selectivity, adjusting the observation if needed to make it logically consistent among a plurality of observations of the data attribute pair, computing a statistic H_{M} of the data attribute pair, determining whether the data attribute pair is dependent by comparing the statistic H_{M} to a threshold value, determining a dependency measure of the data attribute pair by normalizing the statistic H_{M} with respect to a normalizing factor, and saving the dependency measure of the data attribute pair to a system catalog.

### BACKGROUND OF THE INVENTION

1. Field of the Invention

This invention relates generally to database management, and particularly to a method for detecting data attribute dependencies.

2. Description of Background

Datasets (e.g., files or other electronic collections of data) exhibit, often complex, dependency structures among their data attributes. Detecting these data attribute dependencies is important for a variety of purposes, such as database query optimization, data mining, metadata discovery, and database system management in general. For example, in the context of query optimization, dependency detection is needed for “statistics configuration.” Current approaches to detecting data attribute dependencies include so-called proactive approaches, in which all data is scanned or sampled to detect dependencies, and reactive approaches, in which data from query feedback (i.e., the results of queries) is analyzed to detect dependencies.

However, such proactive approaches can be inefficient or even unfeasible, e.g., because of high computational needs, such as to examine a large number of data attributes. Furthermore, such reactive approaches can be inefficient or unfeasible, e.g., because of instability when there is a limited number of feedback records, sensitivity to the order in which feedback records are processed, high complexity and computational needs (which may also make such approaches difficult to incorporate and/or maintain in commercial database management systems), and/or lack of flexibility to reduce computational needs for applications other than database query optimization. Therefore, an approach to detect data attribute dependencies is desirable that can be effectively incorporated into database management systems, is stable (e.g., providing accurate detection of data attribute dependencies regardless of the order in which feedback records are processed, even when the number of available feedback records is small), and is flexible (e.g., applicable to various applications in which detection of data attribute dependencies is needed).

### SUMMARY OF THE INVENTION

A method for detecting data attribute dependencies is provided. An exemplary embodiment of the method includes obtaining at least one data attribute pair of a dataset to analyze for dependency, obtaining at least one query feedback record related to the data attribute pair, obtaining at least one observation of the data attribute pair from the query feedback record that includes a selectivity and at least one of a first marginal selectivity or a second marginal selectivity, completing the observation, if it does not include the first marginal selectivity and the second marginal selectivity, by estimating the missing marginal selectivity, adjusting the observation if needed to make it logically consistent among a plurality of observations of the data attribute pair, computing a statistic H_{M} of the data attribute pair, determining whether the data attribute pair is dependent by comparing the statistic H_{M} to a threshold value, determining a dependency measure of the data attribute pair by normalizing the statistic H_{M} with respect to a normalizing factor, and saving the dependency measure of the data attribute pair to a system catalog.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured for detecting data attribute dependencies.

FIG. 2 is a flow diagram illustrating an example of a method for detecting data attribute dependencies, which is executable, for example, on the exemplary computing device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a method for detecting data attribute dependencies is provided. In accordance with such exemplary embodiments, an approach to detect data attribute dependencies is provided that can be effectively incorporated into database management systems, is stable (e.g., providing accurate detection of data attribute dependencies regardless of the order in which feedback records are processed, even when the number of available feedback records is small), and is flexible (e.g., applicable to various applications in which detection of data attribute dependencies is needed).

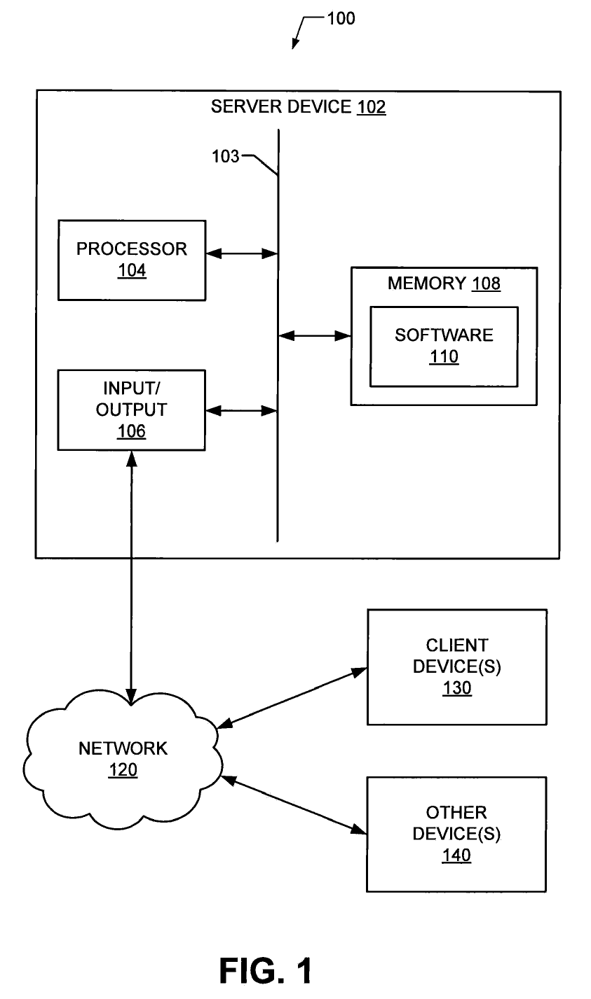

Turning now to the drawings in greater detail, wherein like reference numerals indicate like elements, FIG. 1 illustrates an example of a computer system 100 including an exemplary computing device (“server device” or “server”) 102 configured for detecting data attribute dependencies. In addition to server device 102, exemplary computer system 100 includes network 120, client device(s) 130, and other device(s) 140. Network 120 connects server device 102, client device(s) 130, and other device(s) 140 and may include one or more wide area networks (WANs) and/or local area networks (LANs) such as the Internet, intranet(s), and/or wireless communications network(s). Client device(s) 130 may include one or more other computing devices, e.g., that are similar to server device 102. Other device(s) 140 may include one or more other computing devices, e.g., one or more other server devices, storage devices, etc. Server device 102, client device(s) 130, and other device(s) 140 are in communication via network 120, e.g., to communicate data between them.

Exemplary server device 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from server device 102, such as a display, keyboard, modem, network adapter, ports, etc. (not depicted). Memory 108 includes software 110 for detecting data attribute dependencies, which is executable, e.g., by server device 102 via processor 104. Memory 108 may include other software, data etc. (not depicted).

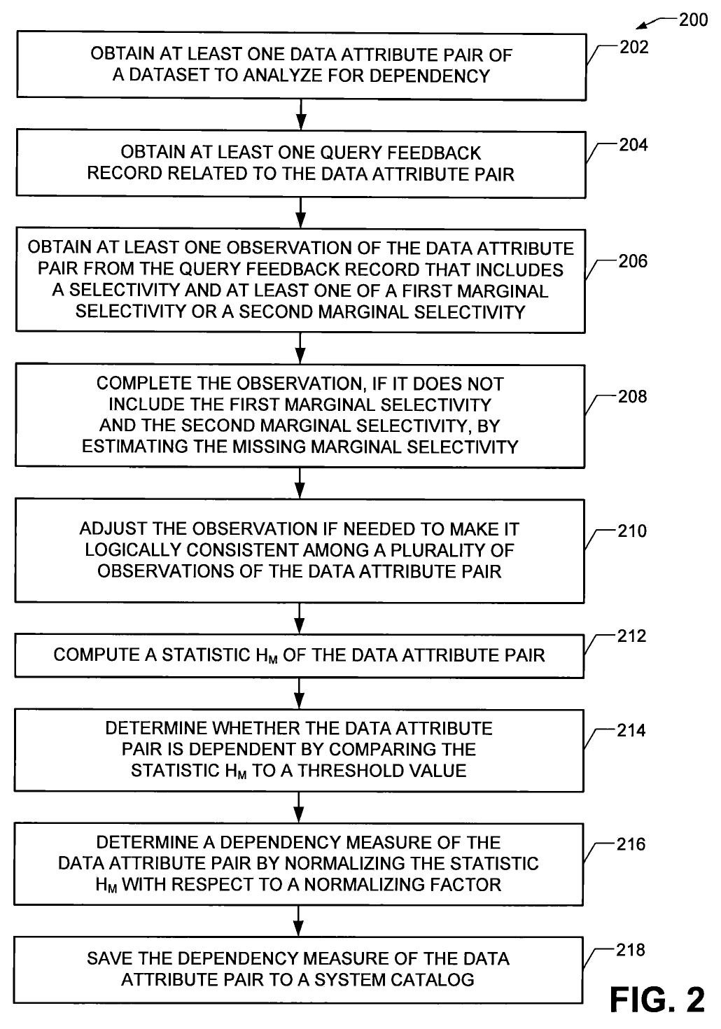

FIG. 2 illustrates an example of a method 200 for detecting data attribute dependencies, which is executable, for example, on the exemplary server device 102 of FIG. 1 (e.g., as a computer program product). In block 202, one or more data attribute pairs that includes a first data attribute and a second data attribute are obtained from a dataset to analyze for dependency. In block 204, one or more query feedback records related to the one or more data attribute pairs is obtained. The query feedback records (“QFRs”) may be obtained, e.g., from a query feedback warehouse in a database system. Relevant QFRs are collected for each attribute pair that is to be analyzed. For example, consider a specified pair of attributes (A,B) and denote by D_{A} (respective D_{B}) the set of distinct values of attribute A (resp. attribute B) that appear in the dataset. In block 206, one or more observations of the one or more data attribute pairs are obtained from the one or more QFRs. For example, an input of a set of observations O={O₁,O₂, . . . ,Oₙ} is obtained from relevant QFRs, where 1≦n<|D_{A}×D_{B}| and each observation Oᵢ concerns a conjunctive predicate of the form “A=αᵢ and B=βᵢ” with αᵢε D_{A} and βᵢε D_{B}.

Each sub-predicate that appears in the conjunctive predicate, e.g., “A=αᵢ” in the above example, is a simple predicate. It is assumed that (αᵢ,βᵢ)≠(αⱼ,βⱼ) for j≠i. Each observation Oᵢ is a set having one of the forms (i) Oᵢ={f_{α}_{ᵢ}_{β}_{ᵢ},f_{α}_{ᵢ}_{·},f_{·β}_{ᵢ}}, (ii) Oᵢ={f_{α}_{ᵢ}_{β}_{ᵢ},f_{α}_{ᵢ}_{·}}, (iii) Oᵢ={f_{α}_{ᵢ}_{β}_{ᵢ},f_{·β}_{ᵢ}}, or (iv) Oᵢ={f_{α}_{ᵢ}_{β}_{ᵢ}}, depending on the feedback that is available. Here, the selectivity f_{αβ} denotes the fraction of elements t in the dataset such that t.A=α and t.B=β, and the marginal selectivities f_{α·}and f_{β·} are computed as appropriate marginal sums: f_{α·}=Σ_{βεD}_{_{B}} f_{αβ} and f_{·β}=Σ_{αεD}_{_{A}}f_{αβ}. Attributes A and B are said to satisfy an “independence assumption” if f_{αβ}=f_{α·}f·_{β} for all possible α and β. If this assumption holds to a good approximation, e.g., if |f_{αβ}−f_{α·}f·_{β}| is small for all values of α and β, then attributes A and B are considered independent; otherwise, attributes A and B are considered dependent. The larger the deviation from the independence assumption, the greater the degree of dependence. In the context of statistics configuration, the “dataset” may include a base table or, more generally, a view computed from one or more base tables, and the observations in O are derived from the QFRs in the feedback warehouse.

A QFR contains the observed cardinality for a (simple or conjunctive) predicate, together with the estimated cardinality computed by a database query optimizer. Whereas, the quantity f_{α}_{ᵢ}_{β}_{ᵢ} is available from the feedback warehouse, the quantities f_{α}_{ᵢ}_{·} and f_{·β}_{ᵢ} may or may not be available, depending on the query plans that were chosen by the optimizer. Suppose, for example, that attributes A and B correspond to columns in a table T. If the simple predicate p₂: “T.B=βᵢ” was applied over the result of the simple predicate p₁: “T.A=αᵢ” in a given query, then f_{α}_{ᵢ}_{·} and f_{α}_{ᵢ}_{β}_{ᵢ} would be available. If, on the other hand, (A,B) is a prefix of an index on table T and both p₁ and p₂ were applied simultaneously, then f_{α}_{ᵢ}_{β}_{ᵢ} would be available. As a final example, f_{α}_{ᵢ}_{·} and f_{α}_{ᵢ}_{β}_{ᵢ} might have been obtained as described above from an execution of some query and f_{·β}_{ᵢ} might also be available based on the execution of a different query in the workload.

In block 208, each incomplete observation (e.g., each observation of the form, Oᵢ={f_{α}_{ᵢ}_{β}_{ᵢ},f_{α}_{ᵢ}_{·}} or Oᵢ={f_{α}_{ᵢ}_{β}_{ᵢ},f_{·β}_{ᵢ}}) is completed by estimating the missing marginal selectivity to convert it to the form Oᵢ={f_{α}_{ᵢ}_{β}_{ᵢ},f_{α}_{ᵢ}_{·},f_{·β}_{ᵢ}}. In practice, and, e.g., particularly in the context of statistics configuration, observations of the form Oᵢ={f_{α}_{ᵢ}_{β}_{ᵢ}}, where both marginal selectivities are missing, are of no concern. Such observations arise, e.g., from the application of a multi-column index, which can be used directly to detect dependencies. An overall goal in estimating a missing marginal selectivity is to be conservative, i.e., to be reluctant to declare the presence of a dependency, because each such declaration leads to increased processing and storage requirements. Therefore, a selectivity value is chosen that is “most consistent” with the independence assumption, subject to knowledge about the range of possible values for this selectivity.

For example, consider the case in which f_{α}_{ᵢ}_{β}_{ᵢ} and f_{α}_{ᵢ}_{·} are known for a given value of i, but f_{·β}_{ᵢ} is not known; the case in which f_{α}_{ᵢ}_{·} is unknown is handled in an analogous manner. By assumption, an estimate \hat{f}_{·β}_{ᵢ} is available (e.g., from a query optimizer) and a known upper bound δ is assumed on the magnitude of the relative error of this estimate. It follows that lᵢ≦f_{·β}_{ᵢ}≦uᵢ, where lᵢ=\hat{f}_{·β}_{ᵢ}/((1+δ) and

$${u}_{i} = \{ \begin{matrix}min ( {\hat{f}}_{\cdot {β}_{i}} / ( 1 - δ ) , 1 ) & if 0 \leq δ \leq 1 ; \\ 1 & if δ > 1.\end{matrix} .$$

The goal is to choose the estimate f*_{·β}_{ᵢ} of f_{·β}_{ᵢ} so as to be most consistent with the independence assumption, that is, to make the ratio f_{α}_{ᵢ}_{β}_{ᵢ}/(f_{α}_{ᵢ}_{·}f*_{·β}_{ᵢ}) as close to 1 as possible. Equivalently, it is desired to make rᵢf*_{·β}_{ᵢ} as close to 1 as possible, where rᵢ=f_{α}_{ᵢ}_{·}/f_{α}_{ᵢ}_{β}_{ᵢ}. However, for some observation Oⱼ={f_{α}_{ⱼ}_{β}_{ⱼ},f_{α}_{ⱼ}_{·}} with j≠i, there may be the case of βⱼ=βᵢ, which implies that it is also desirable to make rⱼf*_{·β}_{ⱼ}*=rⱼf*_{·β}_{ᵢ}* close to 1. In general, setting J={j:βⱼ=βᵢ}, it is desired to find the value y such that rⱼy is close to 1 for all jεJ. Then, this value is used as the estimate of f*_{·β}_{ᵢ}, and hence also of f·._{·β}_{ⱼ} for jεJ. The notion of “close” may be captured via Euclidean distance: e.g., among the possible values yε[l,u] for f·._{·β}_{ᵢ}, where l=lᵢ and u=uᵢ as defined above, select y to minimize g(y)=Σ_{jεJ}(rⱼy−1)²1. Since y₀=Σ_{jεJ}rⱼ/Σ_{jεJ}rⱼ² solves the equation g′(y)=0, the value of y is taken as either l, u, or y₀, depending on which of g(l), g(y₀), and g(u) is smallest. The “deviation function” g(y) measures the deviation from the independence assumption that results from estimating f_{·β}_{ᵢ} (as well as f_{·β}_{ⱼ} for jεJ) by the possible value y. In accordance with other exemplary embodiments, other deviation functions may be used for measuring this deviation, such as g(y)=Σ_{jεJ}|f_{α}_{ᵢ}_{·}y−f_{α}_{ⱼ}_{β}_{ⱼ}|. It is assumed in the foregoing that f_{α}_{ᵢ}_{β}_{ᵢ}>0. If f_{α}_{ᵢ}_{β}_{ᵢ}=0 and f_{α}_{ᵢ}_{·}>0, then the value of f_{·β}_{ᵢ} most consistent with the independence assumption is f_{·β}_{ᵢ}=0 (similar reasoning shows that f_{·β}_{ⱼ}=0 for jεJ). If f_{α}_{ᵢ}_{β}_{ᵢ}=f_{α}_{ᵢ}_{·}=0, then Oᵢ cannot be used to estimate f._{·β}_{ᵢ} and the above procedure is applied using the observations {Oⱼ:jεJ−{i}}. If none of the Oⱼ observations can be used to estimate f._{·β}_{ᵢ}, then the estimate \hat{f}._{·β}_{ᵢ} can be used.

In block 210, the completed observations are adjusted, as needed, to ensure “logical consistency” among them, For example, an observation Oᵢ={f_{α}_{ᵢ}_{β}_{ᵢ},f_{α}_{ᵢ}_{·}.,f._{·β}_{ᵢ}} is logically inconsistent if f_{α}_{ᵢ}_{β}_{ᵢ}>f_{α}_{ᵢ}_{·}., because the number of elements t in the dataset for which both t.A=αᵢ and t.B=βᵢ cannot exceed the number of elements t for which t.A=αᵢ (with no restriction on t.B). Such an adjustment may be needed, e.g., because the QFR observations are obtained at different time points, and updates, deletions from, and insertions to the datasets may occur in between observations, which can cause inconsistencies. Logical inconsistencies can also arise when observations come from different components of a database system, e.g., when some observations are based entirely on query feedback and other observations are derived from statistics that are stored in the system catalog. In some embodiments, considering that QFRs usually have a timestamp, some inconsistencies, such as the presence of two different observations of f_{α}_{ᵢ}_{·}., can be resolved by discarding the observation with the older timestamp. In other embodiments, a update-insert-delete (“UDI”) counter can be monitored, and the QFR warehouse can be purged periodically when the UDI counter exceeds a threshold, where the UDI counter can be reset to zero at each purge. This approach can limit the extent of possible inconsistencies caused by insertions to and deletions from the dataset. In yet other embodiments, a linear-programming method can be applied. For example, this method constructs a linear program in which the feedback observations are treated as constraints, and in which there are other constraints that embody basic probability axioms, e.g., constraints of the form f_{α}_{ᵢ}_{·}≧f_{α}_{ᵢ}_{β}_{ᵢ}, and Σᵢf_{α}_{ᵢ}_{·}≦1. A pair of “slack variables” is added to each constraint. The slack variables represent the adjustments (positive or negative) to the constraints that are needed in order for the complete set of constraints to admit a feasible solution, i.e., for a consistent frequency distribution to exist. The objective function to be minimized is the sum of the slack variables, which corresponds to the sum of the absolute values of the adjustments. Solving the linear program, e.g., using the Simplex Method, yields the minimal adjustments to the observed frequencies needed to resolve any inconsistencies. The terms in the objective function can be weighted so as to favor adjustments to older feedback observations.

In block 212, a statistic H_{M} of the data attribute pair is computed from the (completed and consistency-adjusted) observations in O={O₁,O₂, . . . ,Oₙ}. The value of the statistic H_{M} equals zero when the independence assumption holds and the value of the statistic H_{M} increases as the deviation from the independence assumption increases. For example, the statistic H_{M} may be computed according to H_{M}=Mx^{t}Qx, where M is the number of elements in the dataset; “t” denotes the vector or matrix transpose operation; x=(x₁,x₂, . . . ,xₙ) is a column vector whose entries are given by xᵢ=(f_{α}_{ᵢ}_{β}_{ᵢ}−f_{α}_{ᵢ}_{·}f_{·β}_{ᵢ})/(f_{α}_{ᵢ}_{·}f_{·β}_{ᵢ}) (where 0/0=1); and Q is a pseudo-inverse of a matrix Σ=∥σᵢⱼ∥, where:

$${σ}_{ij} = \{ \begin{matrix}\frac{( 1 - {f}_{{α}_{i} \cdot } ) ( 1 - {f}_{\cdot {β}_{i}} )}{{f}_{{α}_{i} \cdot } {f}_{\cdot {β}_{i}}} & if i = j ; \\ - \frac{1 - {f}_{{α}_{i} \cdot }}{{f}_{{α}_{i} \cdot }} & if i \neq j , {α}_{i} = {α}_{j} , {β}_{i} \neq {β}_{j} \\ - \frac{1 - {f}_{\cdot {β}_{i}}}{{f}_{\cdot {β}_{i}}} & if i \neq j , {α}_{i} \neq {α}_{j} , {β}_{i} = {β}_{j} \\ 1 & if i \neq j , {α}_{i} \neq {α}_{j} , {β}_{i} \neq {β}_{j} .\end{matrix}$$

for 1≦i,j≦n. The matrix Q may be computed by first using known methods to compute the symmetric Schur decomposition of the matrix Σ: Σ=G^{t}DG, where G is a real orthogonal matrix G and D=diag(d₁,d₂, . . . ,dₙ) is a diagonal matrix of non-negative numbers. Denote by r=r(Q) the rank of Q, which equals the number of strictly positive diagonal entries of both D and \tilde{D}. Then set Q=G^{t}\tilde{D}G, where \tilde{D}=diag(\tilde{d}₁,\tilde{d}₂, . . . ,\tilde{d}ₙ), with

$${\tilde{d}}_{i} = \{ \begin{matrix}1 / {d}_{i} & if {d}_{i} > ɛ ; \\ 0 & if {d}_{i} \leq ɛ\end{matrix}$$

for 1≦i≦n, where ε is a small nonnegative number, e.g., which may be chosen as equal to the precision of the computing device.

In some embodiments, the QFRs used for dependency detection and ranking are obtained as a sample of the records in a query feedback warehouse, in order to speed up the computation of H_{M}, which is of order O(n³), where n is the number of observations in O. If, for some reason, the sampling approach does not provide a sufficient decrease in computation cost, then it is possible to further reduce the processing cost by incrementally and approximately maintaining the statistic H_{M}. In some exemplary embodiments, known techniques for incrementally maintaining a singular value decomposition (“SVD”) may be applied, since the symmetric Schur decomposition is a special case of an SVD. An exemplary SVD updating method is the “folding-in” technique, which can be applied in the current setting as follows. Suppose that the dimension of Σ is currently n×n. If a new feedback record is obtained, then it is effectively needed to expand Σ by padding it with 2n+1 elements computed as discussed above for the computation of the vector x. This process can be viewed as appending an n×1 column vector y and then a 1×(n+1) row vector z. Recall that r=r(Q) is the number of positive diagonal entries of D, and fix a positive integer k≦r. By appropriately renumbering the feedback records (and hence permuting the rows and columns of Σ), it can be assumed that the diagonal elements of D appear in descending order from upper left to lower right. Denote by Dₖ the square diagonal submatrix including the first k rows and columns of D; observe that Dₖ is nonsingular. Let Gₖ denote the submatrix obtained from G by dropping all but the first k rows of G. Then the “folding-in” method proceeds by appending first the column vector y^{t}Gₖ^{t}Dₖ⁻¹ and then the row vector zGₖ^{t}Dₖ⁻¹ to Gₖ; the matrix Dₖ remains unchanged. The cost of this update is O(nk). Then H_{M}≈Mxₖ^{t}Gₖ^{t}Dₖ⁻¹Gₖxₖ; computing H_{M} is an O(k²) operation. When k=r and there are no numerical roundoff errors, this process is exact; otherwise, error accrues. The updates can also be batched into blocks of m feedback records, i.e., the vectors y and z can be replaced by n×m and m×(n+m) matrices, respectively. If desired, more accurate (and expensive) updating schemes are possible.

In block 214, a dependency of the data attributes A and B is determined by comparing the statistic H_{M} to a threshold value θ: attributes A and B are determined to be dependent if H_{M}>θ, and independent if H_{M}≦θ. In some exemplary embodiments, θ is the (1−p) quantile of a standard chi-squared distribution with r=r(Q) degrees of freedom, where p is the maximum allowable probability (e.g., specified by a user) of erroneously declaring attributes A and B dependent when A and B are actually independent. The intuition underlying this procedure is that, if M is large and if the elements t₁,t₂, . . . ,t_{M} in the dataset were generated as independent and identically distributed samples from a hypothetical “superpopulation” distribution in which attributes A and B were truly independent with marginal frequencies equal to those actually observed, then H_{M} would have approximately a standard chi-squared distribution with r degrees of freedom. Thus θ is chosen so that, under the foregoing “true independence” scenario, the probability that H_{M} exceeds θ (so that A and B are erroneously declared dependent) does not exceed p. This type of superpopulation approach is standard in the theory of survey sampling. In the (unlikely) case in which complete feedback observations are available for all possible pairs (α,β)εD_{A}×D_{B}, then the foregoing procedure essentially reduces to the classical chi-squared test for independence.

In block 216, a dependency measure is computed for the attributes A and B that were determined to be dependent in block 214. Practical data sets may have a large set of dependent attribute pairs. Thus, there may be a need to rank each detected dependent attribute pair in order of decreasing dependency measure. Such a ranking measure for a given pair can be obtained by normalizing the statistic H_{M} computed for that pair to obtain a normalized dependency measure of the form H_{M}/z, where z is a normalizing factor. Normalization is needed to obtain fair comparisons between different data-attribute pairs, since the H_{M} values for different pairs are obtained, in general, from different numbers of feedback observations. In some exemplary embodiments, z is chosen as the (1−p) quantile of the standard chi-squared distribution with r=r(Q) degrees of freedom. Based on experimentation, values of p between 0.005 and 0.05 yield acceptable results. Other possible choices of z include:

1. Table cardinality: z₁=M. Observe that, when comparing attribute pairs in the same dataset, this normalization is equivalent to using the “raw” value of H_{M}.

2. Minimum number of distinct values in the full dataset: z₂=min(|D_{A}|,|D_{B}|). This normalization is basically the normalization for standard chi-squared analysis of independence.

3. Minimum number of distinct values in the feedback warehouse: z₃=min(|D′_{A}|,|D′_{B}|). Here, D′_{A} (⊂D_{A}) is the number of distinct values of attribute A appearing in the feedback records, and similarly for D′_{B}. This normalization is basically the “feedback version” of the normalization in 2.

4. Minimum number of distinct values used to compute H_{M}: z₄=min(n_{A},n_{B}). Here, n_{A} is the number of distinct αᵢ values actually used in computing H_{M}, and similarly for n_{B}.

5. Degrees of freedom: z₅=r. This normalization can also be viewed as a feedback version of 2 above.

6. Courant-Fischer bound: z₆=M∥x∥²/d*, where d* is the smallest positive diagonal element of the matrix D used to compute H_{M} and ∥x∥² is the sum of the squares of the elements of the vector x used to compute H_{M}. This value of z is an upper bound on H_{M}, and therefore will normalize H_{M} to lie in the range [0,1]. This normalization can be numerically unstable, however, because d* can be close to 0. A desirable normalization z, i.e., the (1−p) chi-squared quantile, can be viewed as a rough approximation of z₆; whereas, z₆ represents an upper bound on H_{M}, the quantity z represents a stable, approximate upper bound that is exceeded with low probability.

In block 218, the dependency measure of the data attribute pair is saved, e.g., to a system catalog for use in a database system. If there are a plurality (e.g., two or more) of data attribute pairs, then the ranked dependency measures of the data attribute pairs are saved. In some exemplary embodiments, if space in the system catalog is limited, the dependency measures of the k most dependent attribute pairs are saved, where the number k may be determined by a user.

Exemplary computer system 100 and server device 102 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary computer system 100 and server device 102, execution of the flow diagram blocks may be implemented with other hardware and/or software architectures that provide the same features, functions, etc. in accordance with exemplary embodiments of the invention.

Exemplary embodiments of the invention can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

What is claimed is:

1. A method for detecting data attribute dependencies, comprising:
obtaining at least one data attribute pair of a dataset comprising a first data attribute and a second data attribute to analyze for dependency;
obtaining at least one query feedback record related to the data attribute pair;
obtaining at least one observation of the data attribute pair from the query feedback record, wherein the observation comprises:
at least one selectivity that is a value of a fraction of elements in the dataset that include a value of the first attribute and a value of the second attribute; and
at least one of:
a first marginal selectivity that is a fraction of the elements in the dataset that include the value of the first attribute; or
a second marginal selectivity that is a fraction of the elements in the dataset that include the value of the second attribute;
completing the observation, if it does not include the first marginal selectivity and the second marginal selectivity, by estimating the missing one of the first marginal selectivity or the second marginal selectivity to be an estimate value within a range of predetermined possible values (y) that minimizes a deviation function (g(y)), wherein the deviation function (g(y)) measures a deviation from an independence assumption resulting from estimating the missing one of the first marginal selectivity or the second marginal selectivity with one of the predetermined possible values (y), and wherein the independence assumption is that the data attribute pair is independent if each selectivity is equal to the first marginal selectivity multiplied by the second marginal selectivity;
adjusting the observation if needed to make it logically consistent among a plurality of observations of the data attribute pair;
computing a statistic (H_{M}) of the data attribute pair from the at least one observation, wherein a value of the statistic (H_{M}) equals zero when the independence assumption holds and the value of the statistic (H_{M}) increases as the deviation from the independence assumption increases;
determining whether the data attribute pair is dependent by comparing the value of the statistic (H_{M}) to a threshold value, wherein:
the data attribute pair is determined to be dependent if the value of the statistic (H_{M}) is greater than the threshold value; and
the data attribute pair is determined to be independent if the value of the statistic (H_{M}) is less than or equal to the threshold value;
determining a dependency measure of the data attribute pair, if the data attribute pair is determined to be dependent, by normalizing the statistic (H_{M}) with respect to a normalizing factor; and
saving the dependency measure of the data attribute pair to a system catalog for use in a database system.

2. The method of claim 1, wherein:
computing a statistic (H_{M}) comprises computing the statistic (H_{M}) according to H_{M}=Mx^{t}Qx, wherein:
M is a number of the elements in the dataset;
x is a column vector (x₁,x₂, . . . ,xₙ), wherein
xᵢ=(f_{α}_{ᵢ}_{β}_{ᵢ}−f_{α}_{ᵢ}_{·}f_{·β}_{ᵢ})/(f_{α}_{ᵢ}_{·}f_{·β}_{ᵢ}), f_{α}_{ᵢ}_{β}_{ᵢ} is the selectivity, f_{α}_{ᵢ}_{·} is the first marginal selectivity, f_{·β}_{ᵢ} is the second marginal selectivity, and 0/0=1, for 1≦i≦n;
n is a number of observations from which the statistic (H_{M}) is computed; and
Q is a pseudo-inverse of a matrix (Σ=∥σᵢⱼ∥), wherein:
$${σ}_{ij} = \{ \begin{matrix}\frac{( 1 - {f}_{{α}_{i} \cdot } ) ( 1 - {f}_{\cdot {β}_{i}} )}{{f}_{{α}_{i} \cdot } {f}_{\cdot {β}_{i}}} & if i = j ; \\ - \frac{1 - {f}_{{α}_{i} \cdot }}{{f}_{{α}_{i} \cdot }} & if i \neq j , {α}_{i} = {α}_{j} , {β}_{i} \neq {β}_{j} \\ - \frac{1 - {f}_{\cdot {β}_{i}}}{{f}_{\cdot {β}_{i}}} & if i \neq j , {α}_{i} \neq {α}_{j} , {β}_{i} = {β}_{j} \\ 1 & if i \neq j , {α}_{i} \neq {α}_{j} , {β}_{i} \neq {β}_{j} .\end{matrix}$$
for 1≦i, j≦n; and
comparing the statistic (H_{M}) comprises comparing the statistic (H_{M}) to a threshold value that is a (1−p) quantile of a standard chi-squared distribution with a number of degrees of freedom equal to a rank (r(Q)) of the pseudo-inverse (Q), wherein p is a maximum allowable probability of erroneously determining that the data attribute pair is dependent when it is actually independent.

3. The method of claim 2, wherein computing a statistic (H_{M}) of the data attribute pair further comprises incrementally maintaining the statistic (H_{M}) by adding a new row and a new column to the matrix (Σ) for each new observation of the data attribute pair, and updating the pseudo-inverse (Q) by updating a singular value decomposition of the matrix (Σ).

4. The method of claim 2, wherein the normalizing factor for determining a dependency measure of the data attribute pair comprises the (1−p) quantile of the standard chi-squared distribution with the number of degrees of freedom equal to the rank (r(Q)) of the pseudo-inverse (Q), wherein 0.005≦p≦0.05.

5. The method of claim 1, wherein:
obtaining at least one query feedback record related to the data attribute pair comprises sampling a contents of a query feedback warehouse.

6. The method of claim 1, wherein completing the observation when the observation does not include the second marginal selectivity comprises:
obtaining an estimate (\hat{f}_{·β}_{ᵢ}) of the second marginal selectivity (f_{·β}_{ᵢ}) and an upper bound (δ) on a magnitude of a relative error of the estimate of the second marginal selectivity from a query optimizer, wherein:
lᵢ≦f_{·β}_{ᵢ}≦uᵢ;
lᵢ=\hat{f}_{·β}_{ᵢ}/(1+δ); and
$${u}_{i} = \{ \begin{matrix}min ( {\hat{f}}_{\cdot {β}_{i}} / ( 1 - δ ) , 1 ) & if 0 \leq δ \leq 1 ; \\ 1 & if δ > 1.\end{matrix} ;$$
estimating the second marginal selectivity as: arg minₗ_{ᵢ}_{≦y≦u}_{ᵢ}Σ_{jεJ}(rⱼy−1)² if f_{α}_{ᵢ}_{β}_{ᵢ}>0, wherein J={j:βⱼ=βᵢ} and rⱼ=f_{α}_{ⱼ}_{·}/f_{α}_{ⱼ}_{β}_{ⱼ};
estimating the second marginal selectivity as f_{·β}_{ᵢ}=0 if f_{α}_{ᵢ}_{β}_{ᵢ}=0 and f_{α}_{ᵢ}_{·}>0;
estimating the second marginal selectivity based on observations {Oⱼ:jεJ−{i}} if f_{α}_{ᵢ}_{β}_{ᵢ}=d_{α}_{ᵢ}_{·}=0; and
estimating the second marginal selectivity as the estimate (\hat{f}_{·β}_{ᵢ}) if none of the observations can be used to estimate the second marginal selectivity.

7. The method of claim 1, wherein adjusting the observation comprises:
using a timestamp of the observation to resolve inconsistencies with the plurality of observations by discarding older observations of the data attribute pair;
using an update-insert-delete (UDI) counter to limit the inconsistencies by monitoring the UDI counter and periodically purging a query feedback record warehouse when the UDI counter exceeds a counter threshold value, wherein the UDI counter is reset to zero at each purge; or
using a linear program to resolve inconsistencies by determining and applying minimal adjustments of observations of the data attribute pair according to the linear program.
